(19) United States
(12) Patent Application Publication
(10) Pub. No.: US 2014/0298580 A1
(43) Pub. Date: Oct. 9, 2014

(54) Childs Pot

(71) Applicant: Rachael Louise Forder, Southsea (GB)

(72) Inventor: Rachael Louise Forder, Southsea (GB)

(21) Appl. No.: 14/359,689

(22) PCT Filed: Nov. 21, 2012
(86) PCT No.: PCT/GB2012/000850

§ 371 Date: May 21, 2014

(30) Foreign Application Priority Data
Nov. 22, 2011 (GB) 1120182.9

(51) Int. Cl. A47K 11/06; F21V 33/00

(52) U.S. Cl. CPC A47K 11/06; F21V 33/004
USPC 4/449

(57) ABSTRACT

A child's pot has a front deflector, and a back to lean against and a handle aperture. The back has a recess for receiving a lamp. This has a body in a front part of which is mounted a lens and a detector above the lens. On a circuit board within the lamp, the an infra-red motion sensor and three LEDs for illumination are provided. A compartment for batteries inside a cover is provided behind the circuit board. The cover is provided with a moisture excluding seal and is mounted in a rear part of the body. The parts and the lens are sealed together. The rear part has an integrally moulded detent button on a resilient (finger 19).

The present invention relates to a child's pot.

It is known to form a pot of luminous material, to assist a toddler in finding it at night.

Motion sensitive torches are known but these are not suitable for use by a toddler.

Lights associated with lavatories are known for assisting adults in use of the lavatory at night. The abstract of U.S. patent application No 2011/0133648 is as follows:

A self contained lightweight device for providing night time illumination into a toilet bowl consists of an LED powered by internal battery enclosed in a small plastic housing. The device is designed to attach to the top of the bowl and beneath the toilet seat so that when the seat is lifted the light turns on. The light goes out when the seat is returned to the closed position or after a predetermined amount of time.

The abstract of U.S. Pat. No. 5,276,595 is as follows:

A toilet light assembly for use at nighttime includes a toilet seat position sensor, a color-coded light comprised of two light sources each of a different color, a chime generator, a person sensor and a darkness sensor. When a person in darkness is sensed in the vicinity of the toilet, the assembly energizes the color-coded light in response to the toilet seat position sensor. If the seat is up, the toilet area is illuminated with red lighting and a brief chime is sounded. If the seat is down, the toilet area is quietly illuminated with green lighting. Thus the invention provides a colorful and unambiguous indicator of the position of the seat and provides a comfortable level of lighting to automatically facilitate night-time use of the toilet.

These devices are of no assistance to a toddler requiring assurance to get out of bed at night to use the pot, since a toddler is unable to lift the seat let alone find the lavatory.

Devices also exist for helping with potty training by rewarding a child for use of the pot. For instance, the abstract of U.S. Pat. No. 6,828,788 is as follows:

A toilet training assembly includes a stool comprising a panel and a plurality of legs that are attached to and extend downwardly from the panel. The panel has a centrally disposed aperture therein. A receptacle is removably mountable in the aperture. A back member is attached to a back edge of the stool. A pair of arms is attached to and extends forward from the back member. A motion detector is mounted in the peripheral edge of the aperture and is directed downwardly such that the motion detector detects material entering the receptacle. A processor is electrically coupled to the motion detector. A dispenser assembly for selectively dispensing candy is positioned in a first arm of the pair of arms. The assembly is operationally coupled to the processor so that the dispenser assembly is turned on when the motion detector detects motion.

It should be noted that in this case, the “motion” to be detected is a bowel motion.
This device is of no assistance to the child in finding the pot in a dark bedroom.

The object of the present invention is to provide an improved child's pot

According to the invention there is provided a child's pot for use in a child's bedroom, the pot having:
a lamp fitted to it for lighting the pot's position in the bedroom for the child's use of it at night, the lamp having:
   a sensor adapted and arranged to switch on the lamp on sensing of motion of the child within the bedroom.

Normally, the sensor will be adapted and arranged to switch on the lamp on sensing of motion of the child sitting up in bed or sliding from the bed. Preferably, the sensor is positioned on a back of the pot above a seat surface thereof.

Conveniently, the lamp is removably attached, for cleaning of the pot and of the lamp. This can be achieved by providing a recess in an upstanding portion of the pot, the recess being complementary to a body of the lamp and having a detent hole, the lamp body having a detent button resiliently engageable in the detent hole.

Normally the pot is lidless, with the sensor positioned on a back of the pot above a seat surface thereof. However it can be envisaged that the pot could have a lid, which is liftable for use, with the lamp being carried on the lid. In such a pot, the lamp can have at least one light source arranged on the lid for radiating light outwards for the child's assistance when the lid is closed and at least one other light source arranged on the lid for radiating light inwards for the child's assistance when the lid is open.

Such a pot can have a removable liner carried by a liner supporting portion of the pot, the lamp being carried by the liner supporting portion or by a lid where provided.

The lamp can include an incandescent bulb as a light source, but preferably has one or more light emitting diodes.

Preferably the lamp is made sensitive to motion by incorporation of an infra-red motion sensor.

Normally the lamp will be adapted via a timing circuit to remain ON for a sufficient period of time from sensed motion for the child to get out of bed, use the pot and return to bed. Whilst the timed period may run from the first sensed motion, we now prefer to run it from the last sensed motion of the child, as when he/she returns to bed. The timing circuit can be adjustable as to the ON period before switching off. The ON period can be longer than would normally be needed for pot use, whereby once the child is pot-trained the lamp can be used off the pot, such as to enable the child to see to go the lavatory in a bathroom and back to bed.

Conveniently the pot can be of luminous material and/or include luminous portion(s).

To help understanding of the invention, a specific embodiment thereof will now be described by way of example and with reference to the accompanying drawings, in which:

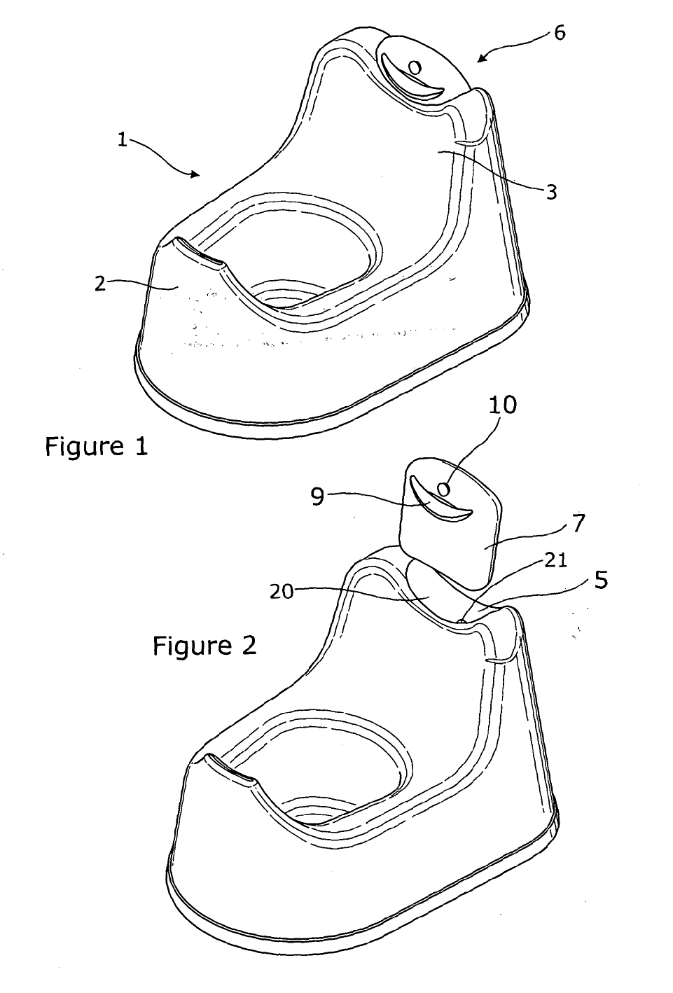

FIG. 1 is a perspective view of a child's pot and lamp of the invention;

FIG. 2 is a similar view with the lamp in position to be fitted to the pot;

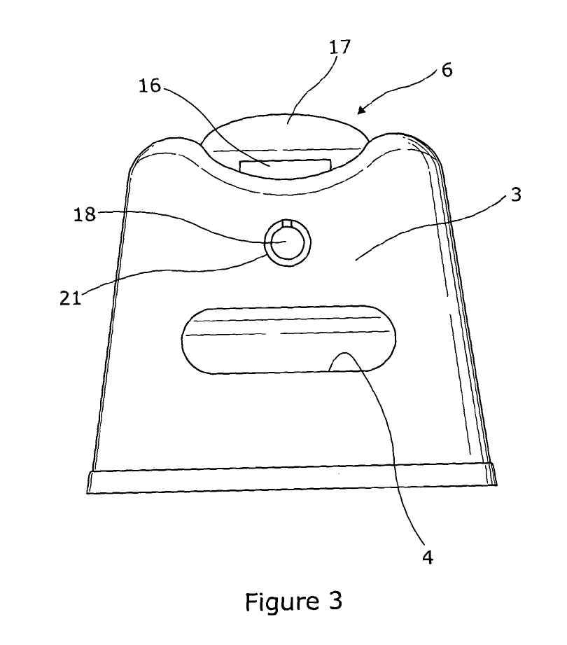

FIG. 3 is a rear view of the pot;

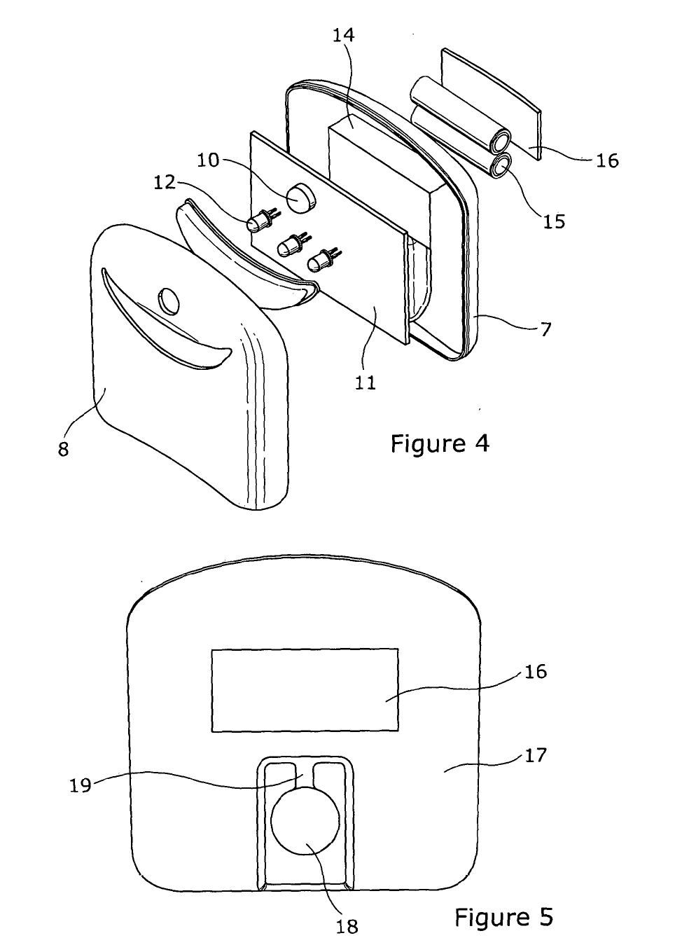

FIG. 4 is an exploded view of the lamp;

FIG. 5 is a rear view of the lamp (on a larger scale than that of FIG. 3);

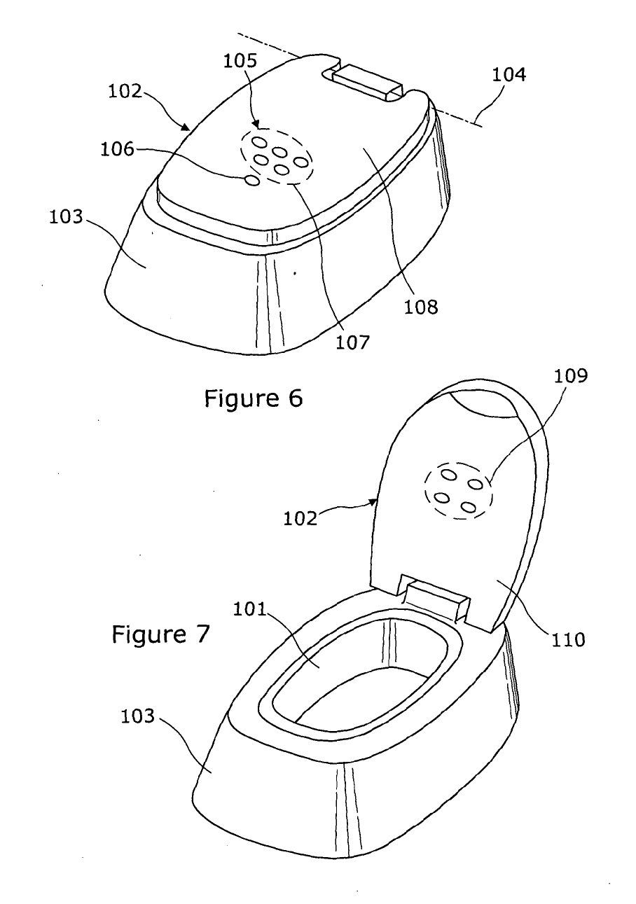

FIG. 6 is a perspective view of an another child's pot and lamp of the invention, with a lid closed; and

FIG. 7 is a similar view of the pot of FIG. 6 with the lid open.

Referring to the drawings, there is shown a child's pot 1, of conventional shape, i.e. with a front deflector 2 to help boys from wetting the floor and a back 3 to lean against and a handle aperture 4. It is moulded of plastics material, conveniently of polypropylene. It can be coloured with plain dye or it can have luminous dye material incorporated.

The back has a recess 5 for receiving a lamp 6. This has a body 7 in a front part 8 of which is mounted a lens 9 and a detector 10 above the lens. On a circuit board 11 within the lamp, the detector 10 and three LEDs 12 for illumination are provided. A compartment 14 for batteries 15 inside a cover 16 is provided behind the circuit board. The cover is provided with a moisture excluding seal and is mounted in a rear part 17 of the body. The parts and the lens are sealed together. The rear part has an integrally moulded detent button 18 on a resilient finger 19.

In a rear face 20 of the recess, which is shaped complementarily with the body of the lamp, a detent hole 21 is provided for receiving the button 18 so that the lamp is removably secure with the lens 9 set above the back.

The detector includes both an ambient light detector and an infra red motion sensor. The sensor is inactive in day light, but active in the dark.

For use, the pot is left by the child's parent in the child's bedroom for the night, close to the child's bed. The sensitivity of sensor is such that turning over of the child in bed is not normally sufficient to cause the LEDs to be illuminated. However, when the child stirs, needing to use the pot, and sits up in bed or slides from the bed, the sensor detects such movement. The circuitry on the board 11 reacts to the detection and switches the LEDs on, enabling the child to see to use the pot. A timer on the board maintains the LEDs on for a determined time, during which the detector is disabled. The timer is set to allow sufficient time for the child to use the pot and return to bed.

It is envisaged that not only will the child feel much more confident about using the pot at night, with the light allowing him/her to see it and its surroundings, but also the child will more quickly become trained to use the pot at night. An advantage of this is the reduction of nappies used as the child grows up.

The invention is not intended to be restricted to the details of the above described embodiment. For instance, instead of luminous dye material being incorporated in the material of the pot, it can have luminous decals applied to its outer wall. For switching the lamp ON/OFF, a switch may be provided within the battery cover, in place of or indeed in addition to the ambient light ON/OFF function of the detector. Further, a control for adjusting the length of time for which the timer maintains the lamp ON. Again, to avoid the light extinguishing during prolonged use of the pot, the detector need not be disabled during the timed illumination period. Rather the timer can be reset for all detected movements, whereby illumination is extinguished after the determined time—typically 60 seconds—after the child has returned to bed.

Further as shown in FIGS. 6 & 7, the basic pot may be of the type having a removable liner 101 and a lid 102, the liner being removable from a carrier 103 and the lid being pivotally carried on the liner about an axis 104 and being liftable for use. A lamp 105, including its motion sensor 106, is carried on the lid, with one array 107 of LEDs on a outer surface 108 of the lid, for radiating light outwards for the child's assistance when the lid is closed. Another array 109 of LEDs is arranged on an inner surface 110 of the lid for radiating light inwards for the child's assistance when the lid is open.

1. A child's pot for use in a child's bedroom, the pot being provided with:
a lamp lamp having:
a sensor adapted and arranged to switch on the lamp on sensing of movement of a child.

2. A child's pot as claimed in claim 1, wherein the sensor is adapted and arranged to switch on the lamp on sensing of movement of the child sitting up in bed or sliding from the bed.

3. A child's pot as claimed in claim, 1 wherein the lamp is removably attached to the pot.

4. A child's pot as claimed in claim 3, wherein the pot has a recess in an upstanding portion thereof, the recess being complementary to a body of the lamp and having a detent hole, the lamp body having a detent button resiliently engageable in the detent hole.

5. A child's pot as claimed in claim 1, wherein the pot is lidless and the sensor is positioned on a back of the pot above a seat surface thereof.

6. A child's pot as claimed in claim 1, wherein the pot has a lid, which is liftable for use and the lamp is carried on the lid.

7. A child's pot as claimed in claim 6, wherein the lamp has at least one light source arranged on the lid for radiating light outwards for the child's assistance when the lid is closed and the lamp has at least one other light source arranged on the lid for radiating light inwards for the child's assistance when the lid is open.

8. A child's pot as claimed in claim 1, wherein the lamp includes as a light source one or more light emitting diodes.

9. A child's pot as claimed in claim 1 wherein the lamp's motion sensor is an infra-red motion sensor.

10. A child's pot as claimed in claim 1, including a timing circuit adapted to maintain the lamp ON for a sufficient period of time from sensed movement for the child to get out of bed, use the pot and return to bed.

11. A child's pot as claimed in claim 10, the timing circuit is arranged to maintain illumination for the period of time after last sensed movement.

12. A child's pot as claimed in claim 1, wherein the pot is of luminous material and/or includes luminous portion(s) and/or decals.

13. A child's pot as claimed in claim 1, wherein the pot has a removable liner carried by a liner supporting portion of the pot, the lamp being carried by the liner supporting portion or by a lid where provided.
